(19) United States
(12) Patent Application Publication
(10) Pub. No.: US 2015/0325126 A1
(43) Pub. Date: Nov. 12, 2015

(54) METHOD FOR DETECTING THE PRESENCE OF A TRAILER

(71) Applicant: Robert Bosch GmbH, Stuttgart (DE)

(72) Inventor: Oliver Schwindt, Novi, MI (US)

(21) Appl. No.: 14/271,650

(22) Filed: May 7, 2014

(51) Int. Cl. G08G 1/16; G01S 17/93; G01S 13/93

(52) U.S. Cl. CPC G08G 1/16; G01S 13/931; G01S 17/936; G01S 2013/9378

(57) ABSTRACT

A method for detecting the presence of a trailer connected to a host vehicle includes a rearward sensor secured on a vehicle that detects the presence of a trailer. An ESC unit determines the velocity of the host vehicle. A rearward sensor determines the velocity of an object and the distance of the object therefrom. When the host vehicle is moving above a minimum velocity, the velocity of the host vehicle is the same as the velocity of the object, and the distance of the object remains essentially the same, a trailer detecting unit determines that the detected object is a trailer attached to the vehicle. Further, when the distance of the object from the rearward sensor is greater than a defined value, the trailer detecting unit determines that a trailer is not attached to the host vehicle.

### BACKGROUND

The present invention relates to a method for detecting the presence of a trailer connected to a vehicle.

In the known prior art, U.S. Pat. No. 7,301,479 discloses a trailer detection circuit that detects the presence of a trailer and automatically disables a parking assist system. U.S. Pat. No. 7,786,849 discloses a trailer detection system for alerting a driver to the relative position of a trailer by sensing objects rearwardly and sidewardly from the vehicle and by sensing the steering angle of the vehicle.

### SUMMARY

In one embodiment, the invention provides a method of detecting presence of a trailer being towed by a host vehicle comprising the steps of: determining velocity of the host vehicle; detecting velocity and distance of an object spaced outwardly from the rear of the host vehicle; and determining that the object comprises a trailer secured to the host vehicle when 1) the velocity of the host vehicle is greater than or equal to a minimum velocity value, 2) the velocity of the host vehicle is approximately the same as the velocity of the object, and 3) the distance of the object from the host vehicle remains constant.

In another embodiment, the step of determining velocity of the host vehicle comprises obtaining velocity from an electronic stability control unit over a communication bus and the step of detecting the velocity and the distance of the object comprises operating a rearward oriented radar sensor that senses reflection of a wave to determine velocity and distance.

Another embodiment includes the steps of informing the electronic stability control unit of the presence of a trailer and that the object is not determined as a trailer when the distance of the object from the host vehicle is greater than a maximum allowed distance.

In another embodiment, the steps are executed by an algorithm of the trailer detecting unit and a longitudinal axis of the host vehicle and a longitudinal axis of the trailer have a common axis while the host vehicle is driving in a straight line direction and the trailer detecting unit is configured to detect the presence of the trailer while driving in a straight line direction.

In another embodiment, the invention provides a trailer detecting system including a trailer detecting unit for a host vehicle, the trailer detecting unit storing and executing instructions that cause the trailer detecting unit to: receive a velocity of the host vehicle; receive a velocity of an object spaced outwardly from the rear of the host vehicle; receive a distance of the object spaced outwardly from the rear of the host vehicle in relation to the rear of the host vehicle; and determine that the object comprises a trailer secured to the host vehicle when 1) the velocity of the host vehicle is greater or equal to a minimum velocity value, 2) the velocity of the host vehicle is the same as the velocity of the object, and 3) the distance of the object from the host vehicle remains constant.

Other aspects of the invention will become apparent by consideration of the detailed description and accompanying drawings.

### BRIEF DESCRIPTION OF THE DRAWINGS

FIG. 1 is a block diagram of a trailer detecting system.

FIG. 2 is an overhead view of a trailer connected to a host vehicle.

FIG. 3 is a flowchart of a method for determining when a trailer is connected to a host vehicle.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

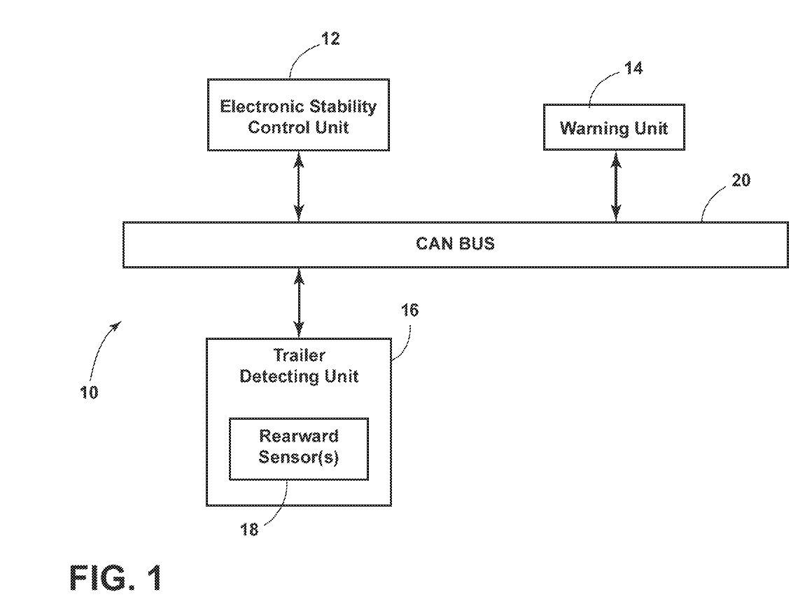

FIG. 1 shows a block diagram of a trailer detecting system 10 that includes an electronic stability control unit (ESC) 12, a warning unit 14, a trailer detecting unit 16 that includes rearward sensor(s) 18. A CAN (controller area network) bus 20 connects the devices and units for communication with each other. Additional vehicle systems utilizing the CAN bus 20, are not shown in FIG. 1.

The ESC unit 12 provides vehicle path driving data and information, such as host vehicle velocity and yaw-rate. The rearward sensor 18 is one or more radar modules, light detecting and ranging (LIDAR) modules, or video detection modules. The rearward sensor senses velocity and distance with respect to an object arranged nearby and rearwardly of a vehicle. For instance, the reflection of a radar wave or a light wave is detected to determine both a distance and a velocity.

A warning unit 14 outputs a visual warning to a display on the host vehicle 24 for various conditions of the host vehicle. In some constructions, the trailer detecting unit 16 is configured to transmit data to the warning unit 14 indicative of the presence of a trailer or other conditions. In some constructions, the warning unit 14 provides a chime or an audible message to a user.

In some constructions, the trailer detecting unit 16 comprises an electronic control unit (ECU) that includes a processor that has an executable program stored in a memory module, such as a ROM. The trailer detecting unit 16 also includes a RAM for storing information from other electronic control units that is received through the CAN bus 20. Non-transitory computer readable memory modules of the trailer detecting unit 16 include volatile memory, non-volatile memory, or a combination thereof and, in various constructions, may also store operating system software, applications/instructions data, and combinations thereof

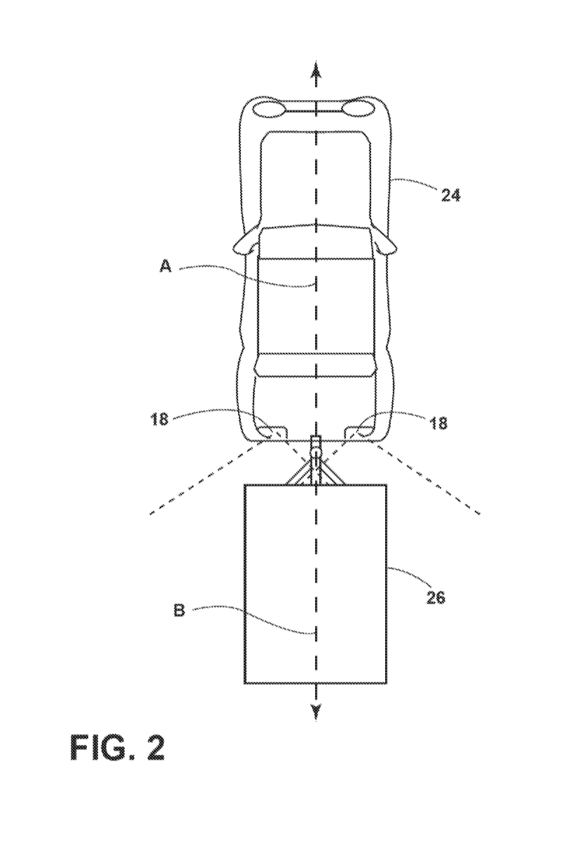

FIG. 2 shows rearward sensors 18 mounted on the rear end of a host vehicle 24. A trailer 26 shown in FIG. 2 is connected to the host vehicle 24. FIG. 2 illustrates a left rear sensor 18 disposed proximate the left rear edge or corner of the host vehicle 24 and a right rear sensor 18 disposed proximate the right rear edge or corner of the host vehicle. The field of view of each respective sensor 18 is represented in FIG. 2 as a dashed line. Further, in FIG. 2, a longitudinal axis A of the host vehicle 24 is essentially coaxial with a longitudinal axis B of the trailer 26 as the vehicle is moving in a straight line forward direction. Thus, the axes A, B, define a common shared axis, or the two axes are only offset vertically from each other.

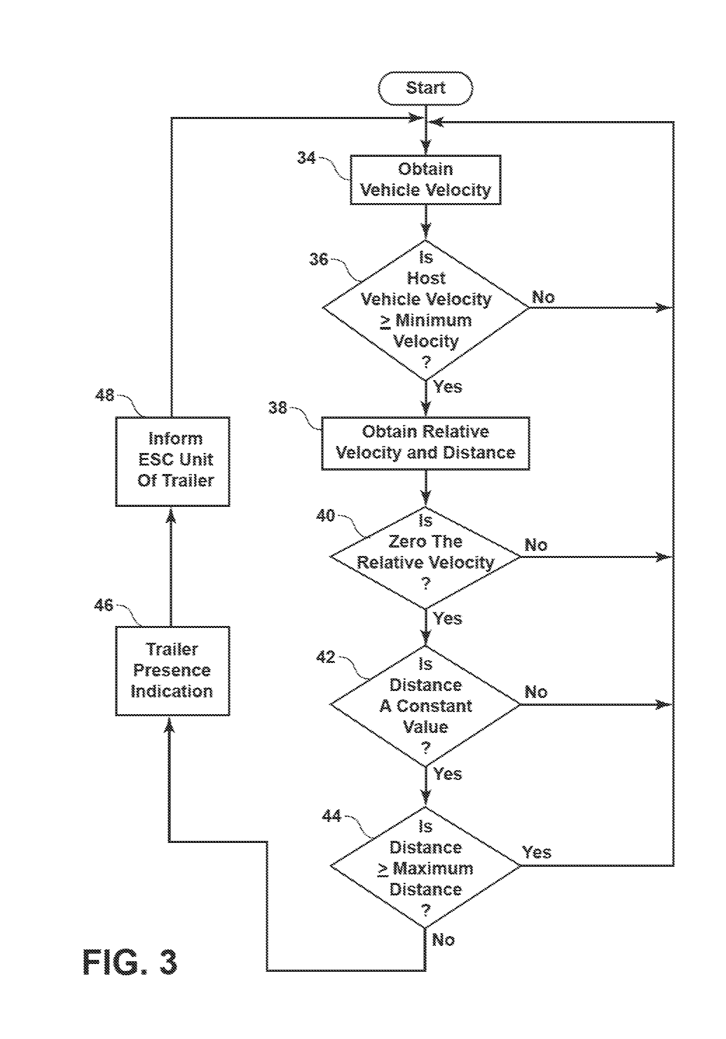

FIG. 3 is a flowchart 30 illustrating one method in which the trailer detecting system 10 of FIG. 1 monitors for the presence of a trailer 26 at the rear and adjacent the host vehicle 24. In the example of FIG. 3, operation of only one of the rearward sensors 18 is discussed. The other sensor 18 operates in a similar manner if multiple sensors are provided in an embodiment. The steps shown in FIG. 3 are for purposes of illustration, and thus the order of the steps can be changed in many instances while having no effect on execution of the program by the trailer detecting unit 16.

Upon starting of the algorithm illustrated by the flowchart in FIG. 3, at step 34, the ESC unit 12 provides a velocity of the host vehicle 24 to the trailer detecting unit 16. At decision step 36, the velocity of the host vehicle is compared with a defined minimum velocity value. If the measured velocity is not greater than or equal to the defined minimum velocity, the algorithm does not continue determining the presence of a trailer. By not sensing without a minimum velocity or speed for the host vehicle, a car stopped behind a stopped host vehicle will not be unintentionally determined as a trailer.

When a minimum velocity is sensed for the host vehicle, the program advances to step 38. At step 38, the sensor(s) 18 at the rear of the vehicle 24 senses velocity and distance of an object from the rear of the vehicle. The program advances to step 40.

At decision step 40, the measured velocity of the host vehicle 24 is compared to the velocity of the trailer or object sensed by the sensor 18. If the processor of the trailer detecting unit 16 determines the velocities are different, the algorithm returns to step 24 as a trailer is not attached to the host vehicle 24. When the velocities are the same, the algorithm advances to step 42.

At decision step 42, the program determines whether the distance value provided by the sensor 18 on the vehicle is changing or essentially constant. If the distance changes and does not remain constant, the program returns to step 34 and starts executing the algorithm again to determine the presence of a trailer.

At step 42, when the distance value provided by the trailer detecting unit is constant over a defined time period indicating the presence of a trailer, the program advances to step 44. At decision step 44, the program decides if the measured distance is greater than a maximum defined distance. If the measured distance is greater, a trailer is not present and the program restarts. When the measured distance is not greater than the maximum defined distance, the program advances to step 46. At step 46, a trailer presence indication is provided. The trailer detecting unit 16 is configured to provide information indicating the trailer presence to other electronic control units on the CAN bus 20 of the host vehicle 24. At step 48, the trailer presence is provided to the ESC unit 12. The ESC unit 12 is configured to adjust stability control features in the event the trailer 26 is connected to the host vehicle 24.

In another construction, the trailer presence indication is provided to a vehicle driver assistance system (not shown) that provides indications to the warning unit 14 when vehicles are approaching the host vehicle 24 from the rear thereof. Collision avoidance systems would change operation due to the presence of a trailer 26 connected to the host vehicle 24. Further, in some constructions, the trailer detecting unit 16 includes a driver assistance system or is a part of a driver assistance system. In one construction, the trailer detecting unit 16 includes an algorithm that is executed on a processor of a driver assistance system intended to provide collision warnings to the operator of the host vehicle.

Thus, the invention provides, among other things, a method and arrangement for detecting the presence of a trailer hitched to a host vehicle. The information is utilized by the vehicle for various purposes, such as to adjust operation of the ESC unit. Various features and advantages of the invention are set forth in the following claims.

What is claimed is:

1. A method of detecting presence of a trailer being towed by a host vehicle comprising the steps of:
determining velocity of the host vehicle;
detecting velocity and distance of an object spaced outwardly from the rear of the host vehicle; and
determining that the object comprises a trailer secured to the host vehicle when 1) the velocity of the host vehicle is greater than or equal to a minimum velocity value, 2) the velocity of the host vehicle is approximately the same as the velocity of the object, and 3) the distance of the object from the host vehicle remains constant.

2. The method according to claim 1, wherein the step of determining velocity of the host vehicle comprises obtaining velocity from an electronic stability control unit over a communication bus.

3. The method according to claim 1, wherein the step of detecting velocity and distance of the object comprises operating a rearward oriented radar sensor that senses reflection of a wave to determine velocity and distance.

4. The method according to claim 2, including the step of informing the electronic stability control unit of the presence of a trailer.

5. The method according to claim 1, wherein the object is not determined as a trailer when the distance of the object from the host vehicle is greater than a maximum allowed distance.

6. The method of claim 1, wherein the steps are executed by an algorithm of a trailer detecting unit.

7. The method of claim 1, wherein a longitudinal axis of the host vehicle and a longitudinal axis of the trailer have a common axis while the host vehicle is driving in a straight line direction and the trailer detecting unit is configured to detect the presence of the trailer while driving in a straight line direction.

8. A trailer detecting system including a trailer detecting unit for a host vehicle, the trailer detecting unit storing and executing instructions that cause the trailer detecting unit to:
receive a velocity of the host vehicle;
receive a velocity of an object spaced outwardly from the rear of the host vehicle;
receive a distance of the object spaced outwardly from the rear of the host vehicle in relation to the rear of the host vehicle; and
determine that the object comprises a trailer secured to the host vehicle when 1) the velocity of the host vehicle is greater or equal to a minimum velocity value, 2) the velocity of the host vehicle is the same as the velocity of the object, and 3) the distance of the object from the host vehicle remains constant.

9. The trailer detecting system according to claim 8, wherein the trailer detecting unit executes the instructions to determine that the object is not a trailer when the distance of the object from the rear of the host vehicle is greater than a defined distance.

10. The trailer detecting system according to claim 9, further comprising; a communication bus and an electronic stability control unit,
wherein the trailer detecting unit receives the velocity of the host vehicle from the electronic stability control unit via the communication bus.

11. The trailer detecting system according to claim 10, further comprising a rearward sensor disposed at the rear of the host vehicle, the rearward sensor providing the velocity and the distance of the object spaced outwardly from the rear of the host vehicle to the trailer detecting unit via the communication bus.

12. The trailer detecting system according to claim 11, wherein the rearward sensor comprises at least one of a radar sensor, a lidar sensor and a video sensor.

13. The trailer detecting system according to claim 8, further comprising a rearward sensor disposed at the rear of the host vehicle, the rearward sensor providing the velocity and the distance of the object spaced outwardly from the rear of the host vehicle.

14. The trailer detecting system according to claim 8, further comprising; a communication bus and an electronic stability control unit,
wherein the trailer detecting unit receives the velocity of the host vehicle from the electronic stability control unit via the communication bus, and wherein the trailer detecting unit is configured to inform the electronic stability control unit of the presence of a trailer via the communication bus.

15. The trailer detecting system according to clam 8, wherein the trailer detecting unit is configured to detect the presence of the trailer when the host vehicle is moving in a forward direction and a longitudinal axis of the trailer is essentially coaxial with a longitudinal axis of the host vehicle.
